(19) United States
(12) Patent Application Publication
(10) Pub. No.: US 2014/0164951 A1
(43) Pub. Date: Jun. 12, 2014

(54) GROUP NUDGE USING REAL-TIME COMMUNICATION SYSTEM

(71) Applicant: MICROSOFT CORPORATION, Redmond, WA (US)

(72) Inventor: Amit Gupta, Redmond, WA (US)

(73) Assignee: MICROSOFT CORPORATION, Redmond, WA (US)

(21) Appl. No.: 13/709,062

(22) Filed: Dec. 10, 2012

(51) Int. Cl. G06F 3/048

(52) U.S. Cl. CPC G06F 3/048
USPC 715/753

(57) ABSTRACT

A nudge transmission is generated for a group of individuals. The nudge transmission includes context information indicating why it was generated. One or more end points, for each individual in the group, are identified, and the nudge transmission is sent to the end points.

### BACKGROUND

Many current communication systems provide communication between two different users. That is, the communication is carried out on a one-to-one basis. Some such systems provide functionality for one member of the communication to gain the attention of the other member.

By way of example, functionality for gaining the attention of the other participant in a communication session is sometimes referred to as “nudging” or “buzzing” on instant messaging networks. Similarly, such a mechanism currently exists on some social network sites. For instance, one social network site allows an individual to “poke” another individual in order to gain his or her attention. All of these implementations, however, are limited to providing this type of functionality over a connection that exists between only two parties.

Communication systems that allow group communication sessions are becoming more and more prevalent. For instance, chat rooms allow individuals to communicate, in real-time, with groups of people. Similarly, on-line meeting systems and other audio and audio/visual communication systems, allow groups of people to communicate with one another in real-time as well. Telephone systems provide call-in functionality for group teleconferences, and still other communication systems allow individuals to attend meetings, by sharing their desktops, logging on to view group presentations, or to hear group lectures, etc.

It is also becoming more common for individuals to have multiple different communication devices that they use in a given day, or at least frequently. For instance, any given individual may have a cellular telephone or smart phone, a palmtop computer, a laptop computer, a tablet computer, a desktop computer, a multimedia player, a gaming console, or other devices. All of these devices are at least potentially capable of allowing a user to carry out real-time communication with a group of other users.

The discussion above is merely provided for general background information and is not intended to be used as an aid in determining the scope of the claimed subject matter.

### SUMMARY

A nudge transmission is generated for a group of individuals. The nudge transmission includes context information indicating why it was generated. One or more end points, for each individual in the group, are identified, and the nudge transmission is sent to the end points.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative embodiment of a communication architecture.

FIG. 2 is a flow diagram illustrating one embodiment of the overall operation of a nudge system shown in FIG. 1.

FIG. 3 is a flow diagram illustrating the process of nudging a group of individuals in more detail.

FIG. 4A is one illustrative user interface display.

FIG. 4B illustrates one exemplary embodiment of a nudge transmission.

FIG. 5 is a flow diagram illustrating one embodiment of the operation of an automatic nudge system.

FIG. 6 is a block diagram showing various architectures.

FIGS. 7-10 show various mobile devices.

FIG. 11 is a block diagram of one illustrative computing environment.

### DETAILED DESCRIPTION

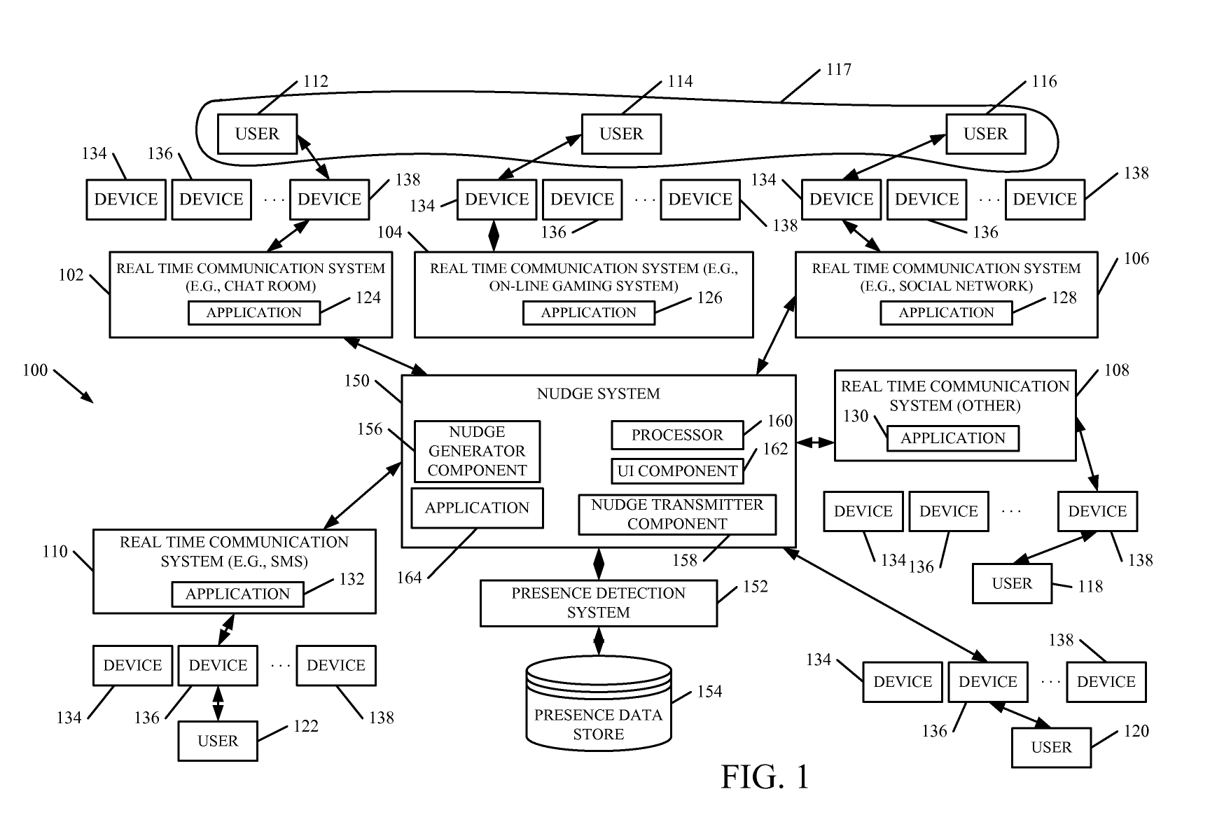

FIG. 1 is a block diagram of one exemplary embodiment of a communication architecture 100 that has a plurality of different communication systems 102, 104, 106, 108 and 110. User's 112, 114, 116, 118, 120 and 122 are shown communicating with one another using communication systems 102-110.

The communication systems 102-110 shown in FIG. 1 are illustratively, in the embodiment shown, real-time communication systems and each includes an application 124, 126, 128, 130 and 132, respectively. By real-time communication, it is meant that the system is a telecommunication system in which groups of users can communicate with one another with no, or negligible, delay. However, the communication systems can also be close to real-time systems or asynchronous as well. The applications 124-130 illustratively allow the various communication systems 102-110 to facilitate communication among various users. As examples of the various applications in the communication systems, application 124 can illustratively be a chat room application that allows a plurality of users to engage in real-time communication in a chat room. Application 126 is illustratively an application that facilitates on-line gaming in which a plurality of different users can participate. Application 128 is illustratively a social network application that allows real-time communication between a plurality of different users. Application 132 is illustratively a short messaging service (SMS) application that allows users to communicate using SMS messaging. Application 130 is illustratively another type of communication application that allows a plurality of users to communicate with one another in real time.

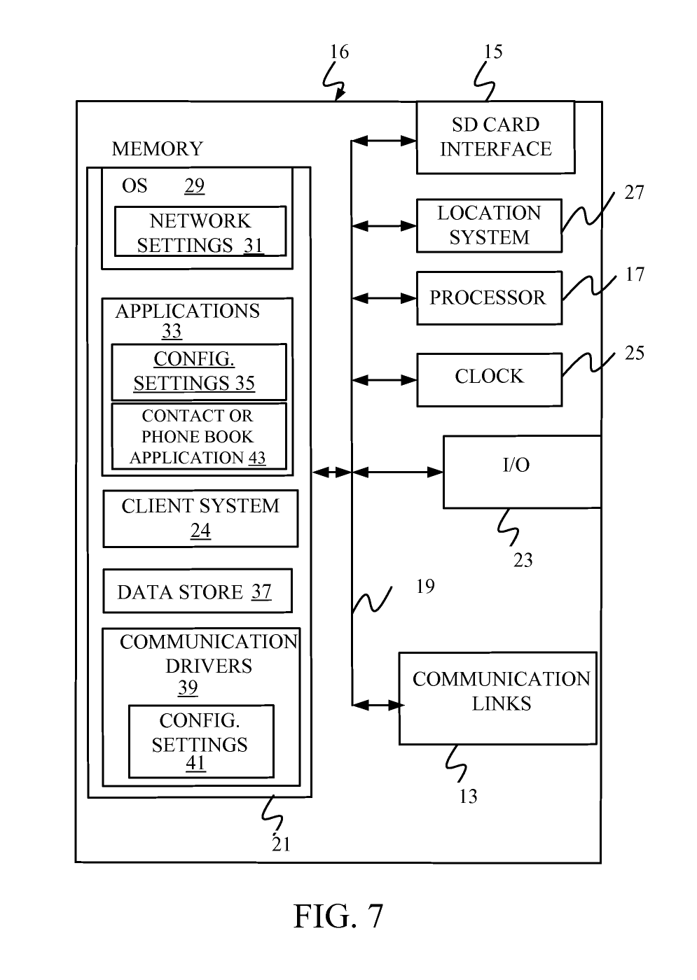

Users 112-122 illustratively have access to one or more user devices illustrated generally with numerals 134, 136 and 138. Each of user devices 134, 136 and 138 can be one of a wide variety of different types of user devices. For instance, each device can be a smart phone, cellular telephone, tablet computer, laptop or palmtop computer, desktop computer, multimedia player, gaming console, or other device. Some examples of such devices are described below with respect to FIGS. 7-11.

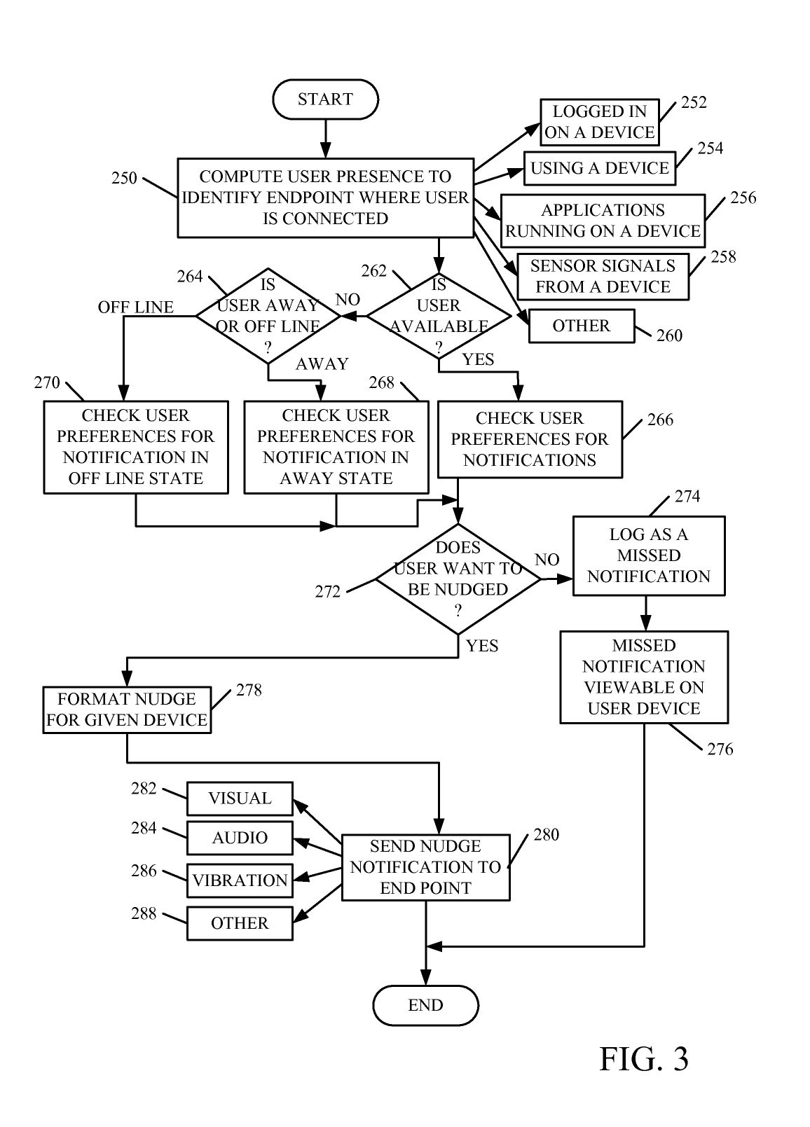

Architecture 100 also shows nudge system 150 and presence detection system 152, that is coupled to presence data store 154. System 150, itself, illustratively includes nudge generator component 156, nudge transmitter component 158, processor 160, user interface (UI) component 162 and one or more applications 164. Presence detection system 152 illustratively monitors various criteria of the devices 134-138 to determine the presence state of a corresponding user. For instance, system 152 can determine whether users 112-122 are present, and available (or active) or actively using, any of devices 134-138, whether they are inactive (or away), or off line and unavailable. This information is stored in presence data store 154. Therefore, at any given time, presence detection system 152 is illustratively able to identify a best device 134-138 for contacting any given user 112-122. The best device may be the device that is most likely to be seen or monitored by the given user, given the preferences or presence state of the given user. Presence detection system 152 is described in greater detail below with respect to FIG. 3.

Nudge system 150 can also illustratively be accessed by users 112-122. UI component 162 illustratively generates user interface displays that can be displayed on devices 134-138, for the various users. The UI displays illustratively allow a given user to identify a group of users to receive a nudge, and then generate the nudge using nudge generator component 156 and transmit the nudge to the group using nudge transmitter component 158. In doing so, user interface component 162 illustratively generates user interface displays with user input mechanisms that receive user inputs to generate and transmit the nudge. The user input mechanisms can be a wide variety of different input mechanisms, such as a text box, a button, a link, a dropdown menu, or another user actuatable input mechanism. Similarly, the users can actuate the user input mechanisms using a wide variety of different devices or techniques as well. For instance, the users can actuate the user input mechanisms using a point and click device (such as a touch pad, track ball or mouse), a hardware or software keyboard or keypad, and where the device being used by a given user includes a speech recognition component, the user can illustratively actuate the user input mechanisms using voice commands. Similarly, where the device being used by the user has a touch sensitive screen, the user input mechanisms can illustratively be actuated using touch gestures, such as with a user's finger, a stylus, etc.

Processor 160 is illustratively a computer processor with associated memory and timing circuitry (not separately shown). Processor 160 is a functional part of nudge system 150 and is illustratively activated by, and facilitates the functionality of, the other components, and applications or items in nudge system 150.

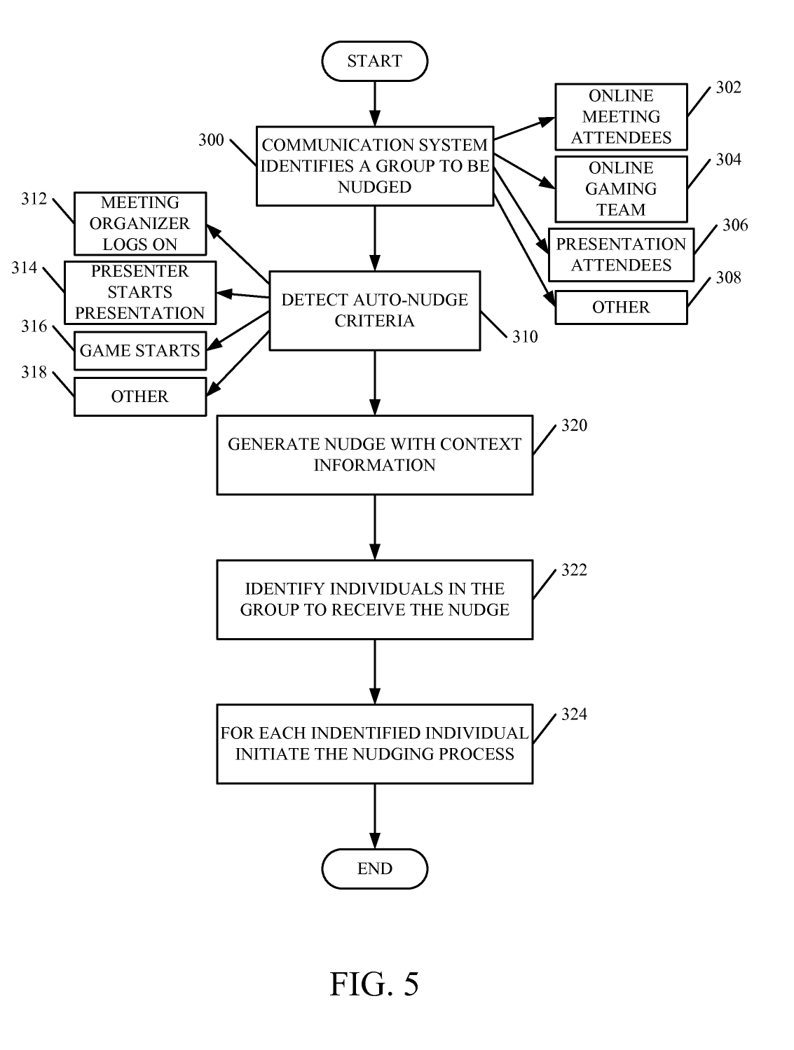

Application 164 illustratively includes an application that uses user interface component 162, nudge generator component 156 and nudge transmitter component 158 to allow a given user to generate and transmit a nudge to a group of other users. In addition, as described below with respect to FIG. 5, application 164 can be used to automatically generate a nudge to a group of users as well.

It will of course be understood that while a single processor 160 is shown, each of the devices 134-138 can have one or more processors as well. Similarly, each of the communication systems 102-110 can also have associated processors and memory. Process detection system 152 can have one or more processors as well.

Also, while presence data store 154 is shown closely coupled to presence detection system 152, it can in fact comprise multiple different data stores which can be either local to system 152, or remote therefrom and accessible by system 152. Similarly, some of the data stores can be local, while others are remote. All of these configurations are contemplated herein.

It should be noted that nudge system 150 can be incorporated into one of the communication systems or applications. It is shown separately for the sake of example only.

Before describing the operation of architecture 100 in more detail, a brief overview will be given to enhance understanding. One of the users, such as user 120, illustratively accesses nudge system 150 to identify a group of a plurality of other users that are to receive a nudge transmission. Nudge generator component 156 illustratively allows user 120 to identify the group of users (such as users 112, 114 and 116 which comprise a group 117) that are to receive the nudge transmission. Nudge generator component 156 then generates the nudge transmission so that it includes both content (which describes the nudge to the group of users) as well as context information, which gives the group of users an idea of why the nudge is being generated. Detection system 152 identifies the particular device 134-138 that is to receive the nudge transmission, for each of the individual users 112, 114 and 116 in group 117. Nudge transmitter component 158 then transmits the nudge transmission to the group 117 of users 112, 114 and 116, and specifically to the identified device 134-138 for each individual user.

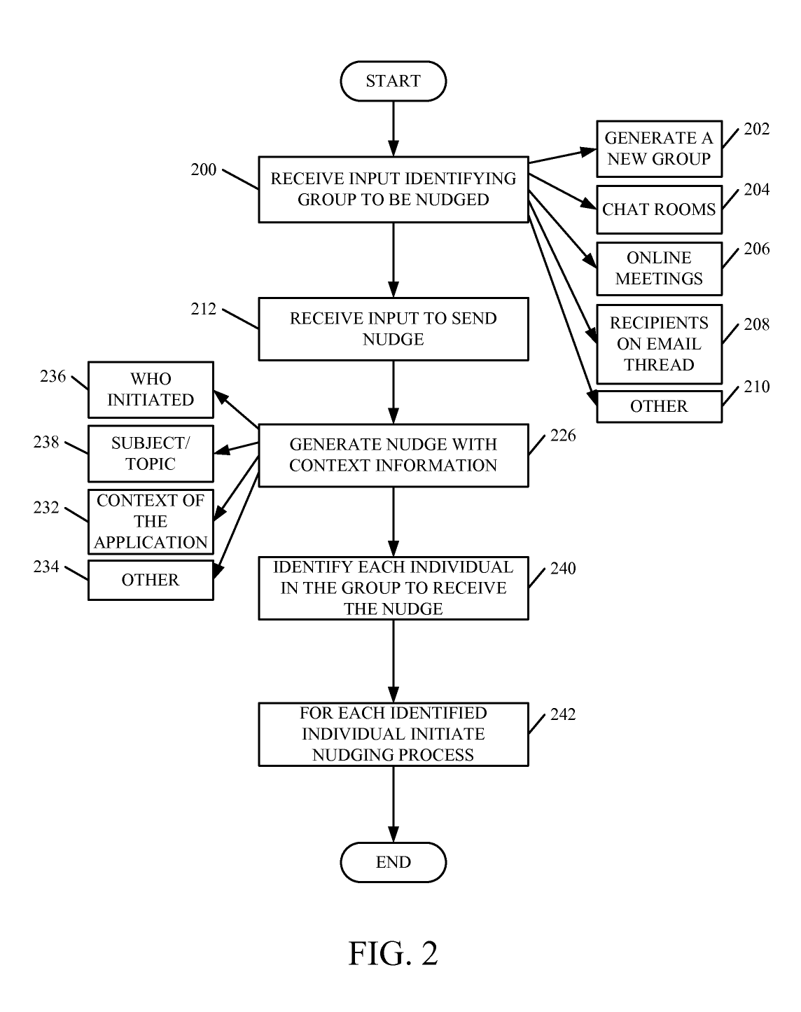

FIG. 2 is a flow diagram illustrating one embodiment of the overall operation of architecture 100 in sending a nudge transmission, in more detail. In discussing FIG. 2, it will be assumed that user 120 is sending a nudge to a group 117 of users 112, 114 and 116. In doing so, user 120 illustratively uses device 136 to access nudge system 150. Accessing system 150 can be done over a network (such as a wide area network) or directly, or by accessing nudge system 150 as a cloud based service, or in other ways.

In any case, nudge generator component 156 first receives an input from user 120 identifying the group to be nudged. This is indicated by block 200 in FIG. 2. This can be done in a variety of different ways as well. For instance, in one embodiment, user 120 generates a new group by selecting users 112, 114 and 116 from a contact list, or in other ways. This is indicated by block 202 in FIG. 2. User 120 can also identify the group by identifying those individuals participating in a real-time discussion in a chat room. This is indicated by block 204. User 120 can identify the group by designating all attendees of an on-line meeting, as indicated by block 206. User 120 can also identify, as the group, all recipients on an email thread. This is indicated by block 208. Of course, user 120 can identify a group of users to receive the nudge transmission in a wide variety of other ways, and this is indicated by block 210.

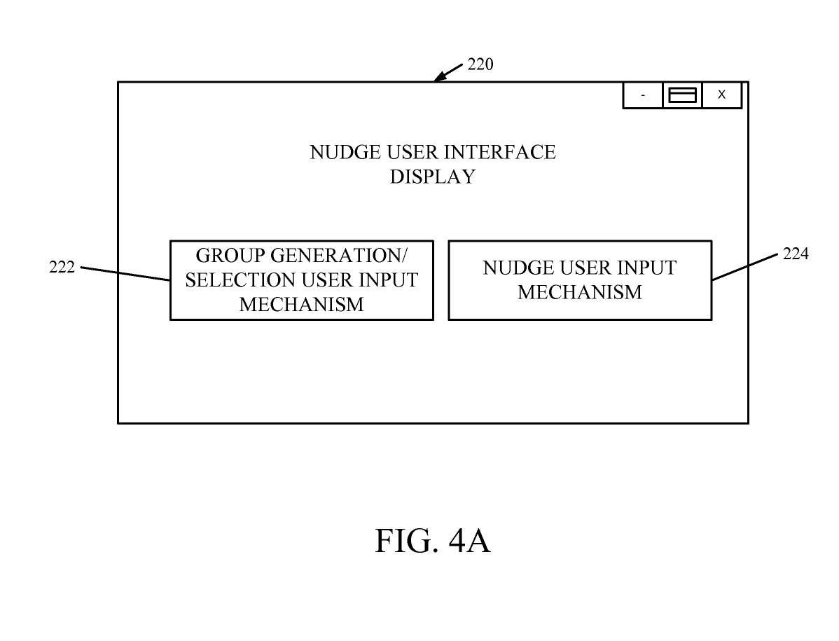

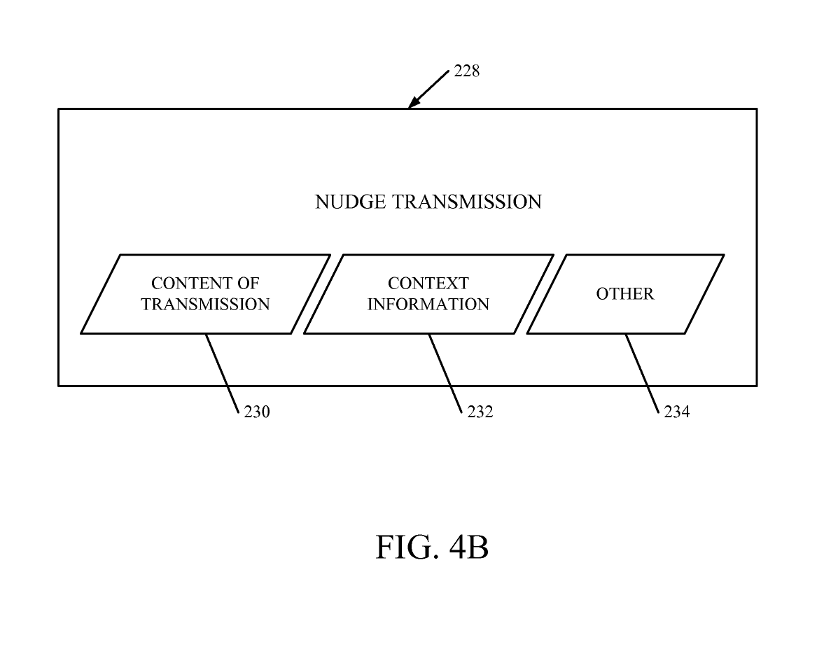

Once the group is identified, user 120 illustratively provides an input to indicate that the nudge transmission should be sent. This is indicated by block 212 in FIG. 2. Again, this can be done in a wide variety of ways. For instance, when nudge generator component 156 generates the nudge transmission, it can use UI component 162 to generate a user interface display that allows user 120 to not only identify the group, but to actually indicate that the nudge transmission should be sent. FIG. 4A shows one illustrative user interface display 220. User interface display 220 includes group generation/selection user input mechanism 222 and nudge user input mechanism 224. In one embodiment, user 120 uses user input mechanism 222 to either create a new group or identify an existing group to receive the nudge transmission. User 120 uses nudge user input mechanism 224 in order to actually indicate that the nudge transmission should be sent. The user input mechanisms can be those described, above, or others. In one embodiment, user input mechanism 224 can be a button. Therefore, after the user identifies the group, the user can send a group nudge simply by clicking the button. Of course, user interface display 220 is exemplary only and a wide variety of other user interface displays could be used as well.

Nudge generator component 156 then generates the nudge transmission with context information. This is indicated by block 226 in FIG. 2. FIG. 4B shows one example of a nudge transmission 228. In the example shown in FIG. 4B, nudge transmission 228 includes a content portion 230 that includes the content of the nudge transmission, such as a textual description of the nudge transmission. For example, the text may be “Please attend the on-line meeting scheduled for noon today.” Nudge transmission 228 may also optionally include context information 232. The context information illustratively includes the context of the application from which the nudge transmission was generated. For instance, the application may be an on-line meeting application, a chat room application, etc. The context of the application is indicated at block 232 in the nudge transmission. Of course, the nudge transmission 228 can include other information, and this is indicated by block 234 in FIG. 4B.

Referring again to FIG. 2, the nudge transmission can include a variety of other information as well. For instance, it can include an identification of who initiated the nudge transmission, as indicated by block 236. It can also include the subject or topic of the nudge transmission as indicated by block 238. It can include the context of the application as indicated by block 232, or it can include other information 234.

Once the nudge transmission has been generated by nudge generator component 156, nudge transmitter component 158 identifies each individual in the group 117 that is to receive the nudge transmission. This is indicated by block 240 in FIG. 2. For instance, each individual may illustratively have an identifier that is used by presence detection system 152. In that case, nudge transmitter component 158 identifies those individuals.

For each identified individual, nudge transmitter component 158 then initiates the nudging process, by which the nudge transmission is sent to each individual in the group 117. This is indicated by block 242 in FIG. 2.

FIG. 3 is a flow diagram illustrating one embodiment of the process of sending the nudge transmission. The flow diagram shown in FIG. 3 is illustratively performed for each of the individuals in group 117 who is to receive the nudge transmission. Presence detection system 152 first computes user presence state (e.g., active, inactive or off line) and to identify user end points where the selected user can likely be reached. This is indicated by block 250 in FIG. 3. An end point, is used herein, is a user device 134, 136 and 138, corresponding to the selected user where the nudge transmission is to be sent, or a specific application on a device. For instance, an end point for a given user may be the user's cell phone. In another embodiment, the end point may be the user's social network application, regardless of the particular device. In yet another embodiment, the end point may be a combination of the two, such as the user's SMS application on the users multimedia player. Presence detection system 152 can identify the end point for a user in a wide variety of different ways. For instance, presence detection system 152 can detect whether the given user is logged in on a particular device 134, 136 or 138. This is indicated by block 252 in FIG. 3.

Presence detection system 152 can also determine whether the given user is using a device. For instance, if the user is talking on the telephone, or logged into a meeting using a laptop computer or desktop computer, for instance, the presence detection system 152 will detect this. This is indicated by block 254 in FIG. 3.

Presence detection system 152 can also identify user presence by determining what applications are running on a given device. For instance, if the user has opened a chat room on a given device, this can indicate that the user is present and currently using that device. Similarly, if the user has opened an online meeting application, this may indicate that the user is present and using that device. This is indicated by block 256 in FIG. 3.

Presence detection system 152 can also receive other signals from various devices to determine user presence. For instance, many smart phones have an accelerometer. If presence detection system 152 detects the signal from the accelerometer, this may indicate that the user is walking, for instance, with the telephone in his or her pocket. In that case, the device that is most likely to contact the user may be that smart phone. Sensing other signals is indicated by block 258 in FIG. 3. Of course, the presence detection system 152 can detect presence in other ways as well, and this is indicated by block 260.

Presence detection system 152 then determines whether the selected user is available to receive the nudge transmission. This is indicated by block 262 in FIG. 3. If not, presence detection system 152 detects whether the selected user is simply away from a given device, or is actually off line. This is indicated by block 264. For example, if a user is logged into a chat room on a desktop computer, but has not contributed any conversation in the chat room, presence detection system 152 may determine that the user is logged in, but is simply away or not paying attention. However, if the user is not logged in anywhere and there is no signal or other indication that the user is available, then presence detection system 152 may indicate that the user is off line.

In any of these instances, (whether the user is available/active, away/inactive or off line) nudge transmitter component 158 checks the user preferences to determine how the user wishes to be notified of a nudge transmission under those circumstances. For instance, if the user is available, the user preferences may indicate that the user wishes to always be notified of a nudge transmission by smart phone. Checking user preferences if the user is available is indicated by block 266.

If the user is away, the user may have set a different preference, such as to be notified by an SMS message on his or her multimedia player. Checking user preferences if the user is away is indicated by block 268.

If the user is off line, the user may have set other preferences indicating yet a different device (or end point) where the user wishes to receive notifications. This is indicated by block 270.

Once the specific end point (e.g., device and/or application) for the selected user has been identified (based on user preferences or user presence or in other ways), nudge transmitter component 158 then determines whether the user wishes to be nudged at all. This is indicated by block 272 in FIG. 3.

By way of example, the user may set preferences to identify a specific device, under various presence states, to receive nudge transmissions. However, it may be that the user simply does not want to receive any nudge transmissions at this time, no matter what. Therefore, the user can simply turn off the nudge system to indicate that he or she does not wish to receive nudge transmissions. The user can illustratively do this without resetting all of the preferences.

If, at block 272, the user does not wish to be notified, then the nudge transmission is simply logged as a missed notification on the specific end point. This is indicated by block 274. Then, the logged, missed notifications can be viewed by the user at the users convenience. This is indicated by block 276.

However, if, at block 272, the user does wish to be nudged, then nudge transmitter component 158 can reformat the nudge transmission for the given device to which the nudge transmission will be delivered. This is indicated by block 278 in FIG. 3. For instance, on a small screen device with relatively limited display real estate, the nudge transmission may be formatted in a relatively simple and small way, with an audio prompt as well. However, for a desktop computer, the nudge transmission may include a more detailed display. These are described by way of example only.

Nudge transmitter component 158 then sends the nudge transmission to the identified end point. This is indicated by block 280 in FIG. 3. Of course, the nudge transmission can be visual as indicated by block 282. It can be audio as indicated by block 284. It can be a vibration as indicated by block 286, or it can be another type of notification, as indicated by block 288. It can also be different combinations of those items as well.

The flow indicated by FIG. 3 is repeated for each individual in the group 117 that is to receive the nudge. It can thus be seen that a user can quickly and easily identify a group to receive a group nudge for a given event or some other reason. Each individual in the group can receive the nudge transmission in the most convenient way based on presence detection. This alleviates the cumbersome nature of repeating nudge transmissions for individuals in one-to-one communication systems.

It should also be noted that the nudge transmission can relate to a task common to all of the individuals in the group (e.g., a meeting where all are attendees, a group presentation, a game, etc.). The common task can be carried out using one communication system even though the nudge to the individuals is carried out using a different one. For instance, the task can be a group meeting using an on-line meeting system and a desktop computer, even though the nudge transmission is sent as an SMS message to a user's smart phone. This is but one example.

FIG. 5 is a flow diagram illustrating one embodiment of the operation of the system shown in FIG. 1 in automatically generating and sending a nudge transmission. Nudge generator component 156 can identify the group to be nudged, automatically, based on the actions of a particular communication system. This is indicated by block 300 in FIG. 5. For instance, if the communication system is an on-line meeting system and there is an on-line meeting scheduled, then the attendees of the on-line meeting can be identified as a group. This is indicated by block 302. If the communication system is an on-line gaming system, then the members of a gaming team may be identified as a group. This is indicated by block 304. If the communication system is an on-line presentation system, then the group may include the members that are to view the presentation. This is indicated by block 306. Of course, there are other ways in which a communication system can identify a group to nudge generator component 156 as well, and this is indicated by block 308.

Nudge generator component 156 then illustratively detects the presence of criteria under which an automatic nudge transmission is to be sent. This is indicated by block 310. For instance, assuming that the communication system is an on-line meeting system and the group that was identified in block 300 includes the attendees of an on-line meeting, then when the meeting organizer logs onto the communication system, this may indicate that all of the attendees are to be nudged. This is indicated by block 312 in FIG. 5.

Similarly, if the communication system is a presentation system and the presenter begins the presentation, this may be criteria for generating an auto nudge to the people who are to view the presentation. This is indicated by block 314. If the communication system is an on-line gaming system and a game has begun, this may indicate that a nudge is to be sent to the team members. This is indicated by block 316. Of course, there are a wide variety of other auto-nudge criteria that can be detected, and this is indicated by block 318.

Once the auto-nudge criteria have been detected at block 310, nudge generator component 156 generates the nudge transmission with the context information, as described above with respect to block 206 in FIG. 2. This is indicated by block 320 in FIG. 3.

Nudge transmitter component 158 then identifies the individuals or the group that is to receive the nudge. This is discussed in greater detail with respect to block 240 in FIG. 2, and it is indicated by block 322 in FIG. 5.

Then, for each identified individual, the nudging process is initiated. This is indicated by block 324 in FIG. 5.

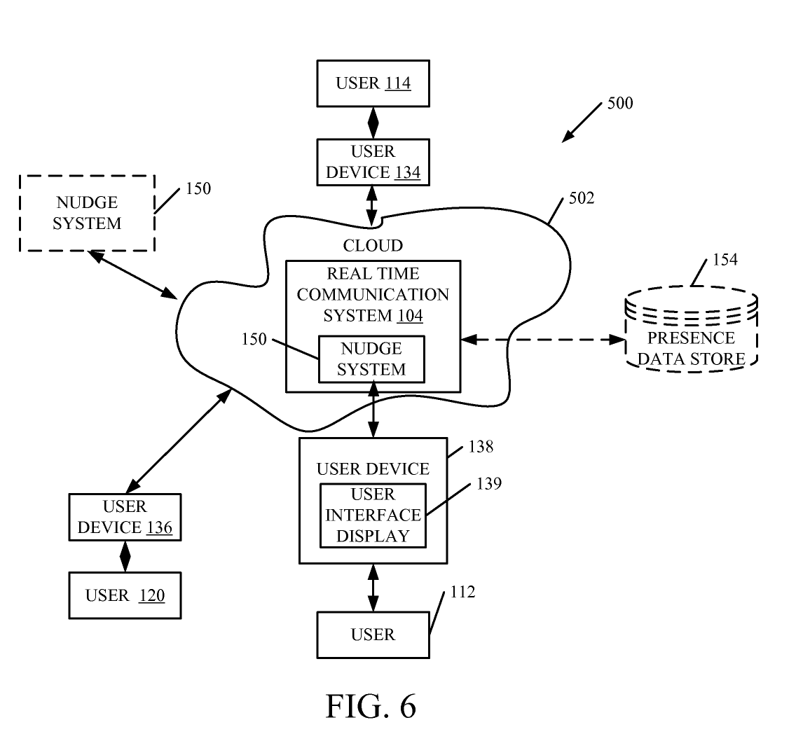

FIG. 6 is a block diagram of a portion of architecture 100, shown in FIG. 1, except that it is disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 6, some items are similar to those shown in FIG. 1 and they are similarly numbered. FIG. 6 specifically shows that nudge system 150 is part of a communication system 104 and is located in cloud 502 (which can be public, private, or a combination where portions are public while others are private). Therefore, users 112, 114 and 120 use user devices 134, 136 and 138 to access those systems through cloud 502.

FIG. 6 also depicts another embodiment of a cloud architecture. FIG. 6 shows that it is also contemplated that some elements of architecture 100 are disposed in cloud 502 while others are not. By way of example, data store 154 can be disposed outside of cloud 502, and accessed through cloud 502. In another embodiment, nudge system 150 is also outside of cloud 502. Regardless of where they are located, they can be accessed directly by the user devices, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

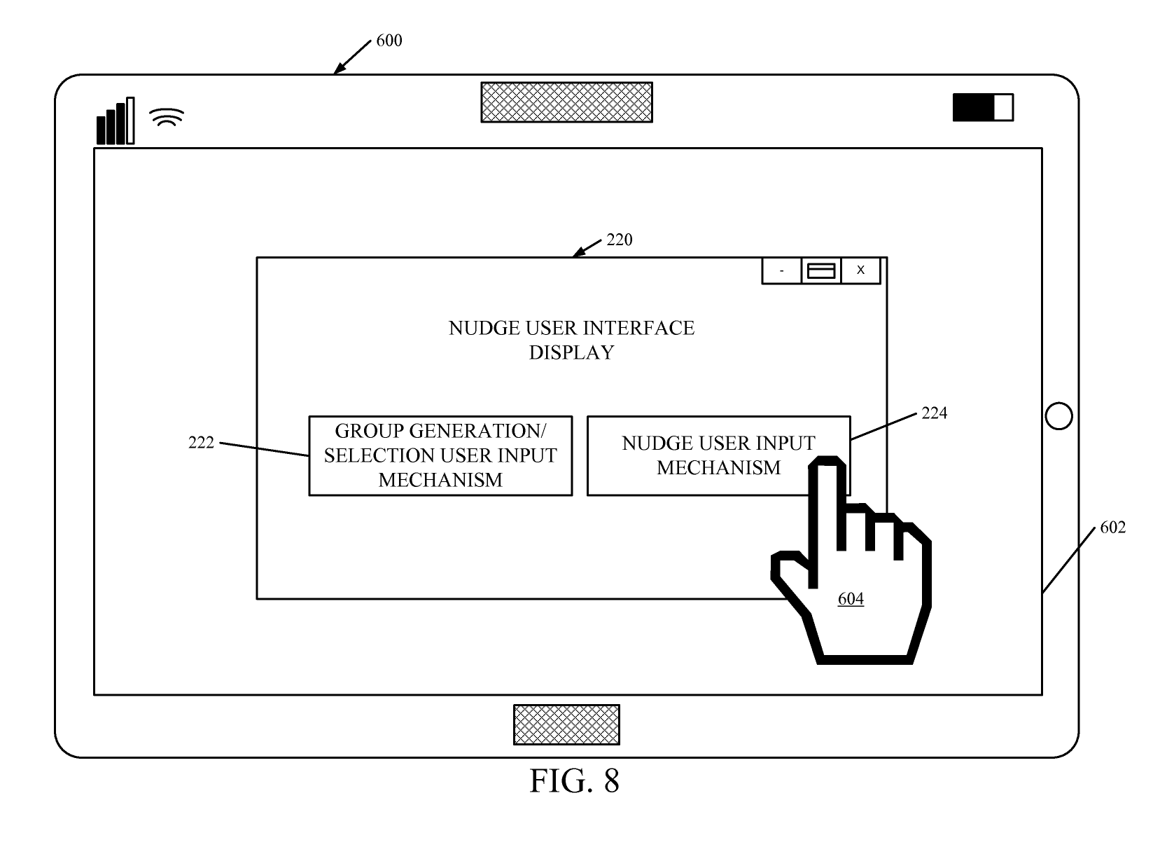

FIG. 7 is a simplified block diagram of one illustrative embodiment of a handheld or mobile computing device that can be used as a user's or client's hand held device 16 (which can be one or more of devices 134, 136 and 138), in which the present system (or parts of it) can be deployed. FIGS. 8-10 are examples of handheld or mobile devices.

FIG. 7 provides a general block diagram of the components of a client device 16 that can run components of architecture 100 or system 150, or that interacts with architecture 100 or system 150, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 150) are received on a removable Secure Digital (SD) card that is connected to a SD card interface 15. SD card interface 15 and communication links 13 communicate with a processor 17 (which can also embody processor 160 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 150 or the items in data store 154, for example, can reside in memory 21. Similarly, device 16 can have a client business system 24 which can run various business applications or embody parts or all of architecture 100 or system 150. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one embodiment in which device 16 is a tablet computer 600. In FIG. 8, computer 600 is shown with the user interface display (shown as 139 in FIG. 6) of FIG. 4A displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

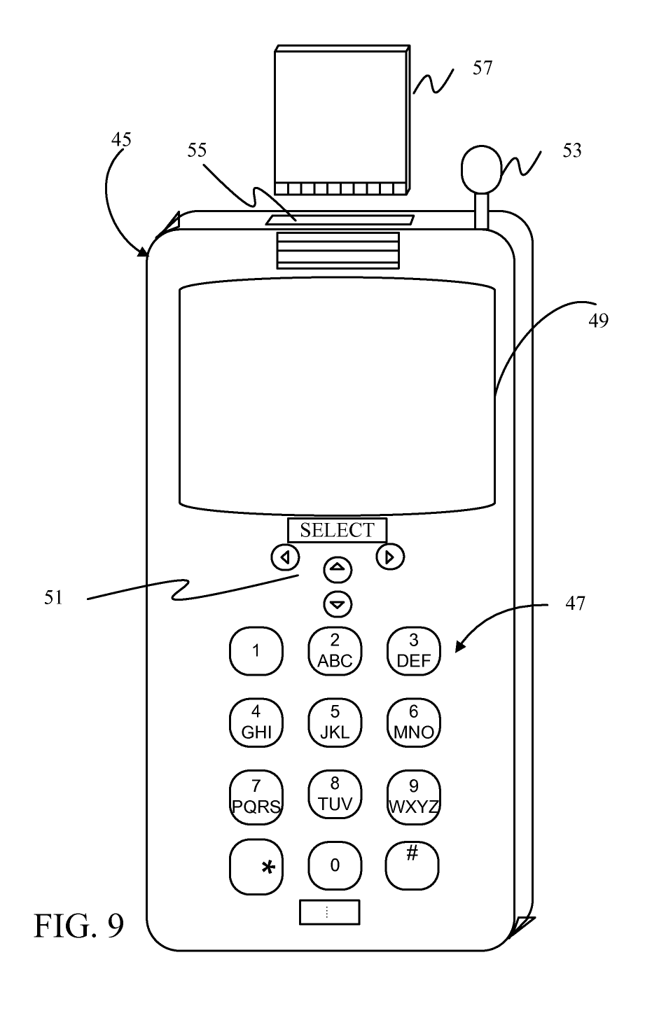

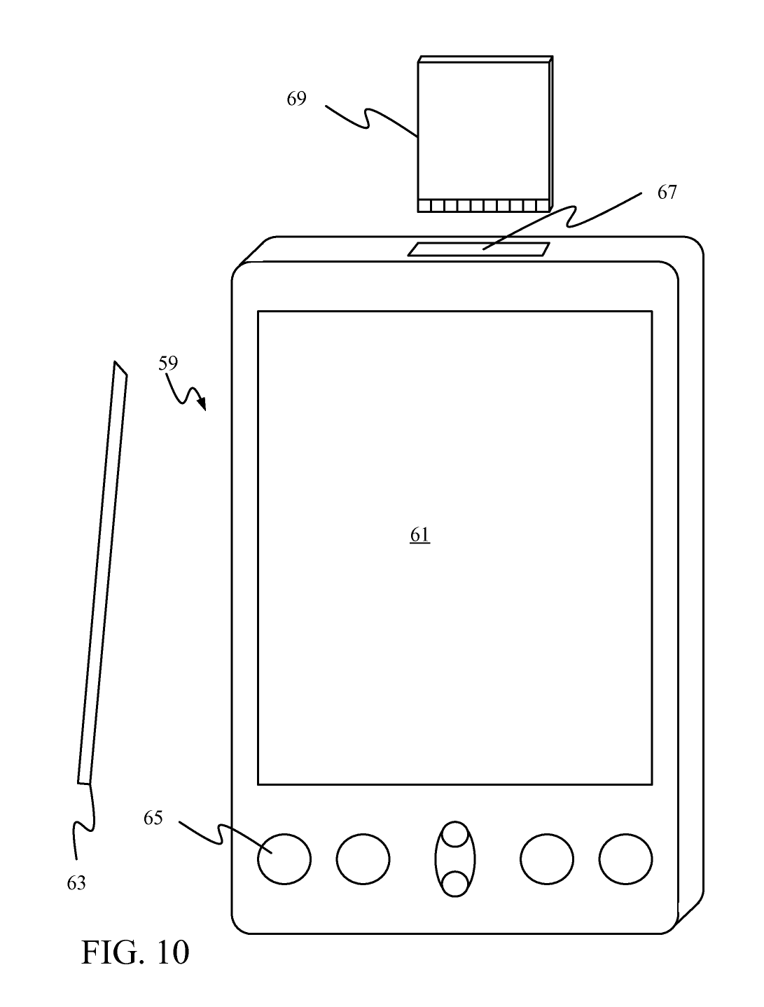

FIGS. 9 and 10 provide additional examples of devices 16 that can be used, although others can be used as well. In FIG. 9, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 10 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

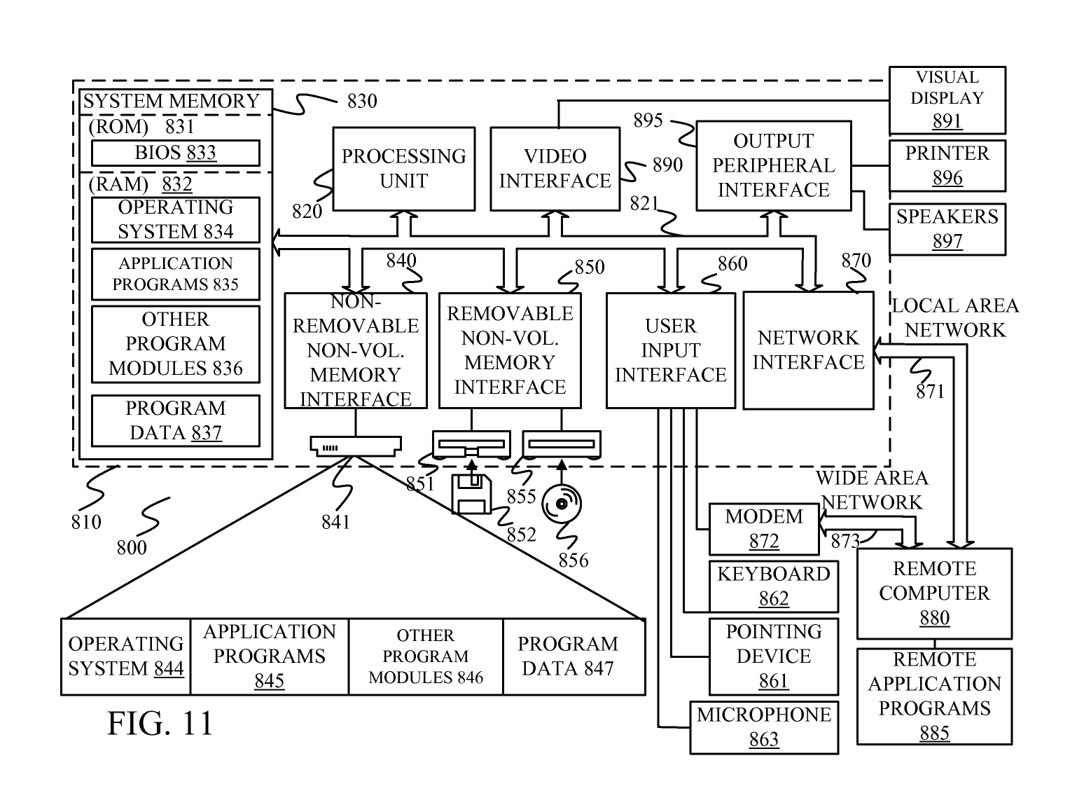

FIG. 11 is one embodiment of a computing environment in which system 150 (for example) or other parts of architecture 100 can be deployed. With reference to FIG. 11, an exemplary system for implementing some embodiments includes a general-purpose computing device in the form of a computer 810. Components of computer 810 may include, but are not limited to, a processing unit 820 (which can comprise processor 160), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It will also be noted that the various embodiments described herein can be combined in different ways. That is, features from one or more embodiments can be combined with features from one or more other embodiments. This type of combination is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A real-time communication system, comprising
a user interface component generating a user interface display with a user input mechanism that receives a group identifier input identifying a group of a plurality of users;
a nudge generation component receiving the group identifier and generating a nudge transmission that includes context information indentifying a task common to the plurality of users;
a nudge transmission component sending the nudge transmission to the plurality of users; and
a computer processor that is a functional part of the system and activated by the nudge generation component and the nudge transmission component to facilitate generating and sending the nudge transmission.

2. The real-time communication system of claim 1, wherein the nudge transmission component receives a user presence input corresponding to each given user in the group and sends the nudge transmission to a specific end point, corresponding to the given user based on the user, presence input.

3. The real-time communication system of claim 2 and further comprising:
a user presence detection system detecting device inputs from each of a plurality of devices corresponding to each user in the group and generating the user presence input based on the detected device inputs.

4. The real-time communication system of claim 2 wherein the nudge transmission component accesses user preferences for the given user and sends the nudge transmission to the specific end point based on the user preferences.

5. The real-time communication system of claim 4 wherein the user presence input identifies a user presence state and wherein the nudge transmission component accesses a specific set of user preferences for the given user based on the user presence state corresponding to the given user.

6. The real time communication system of claim 2 wherein the specific end point comprises one of a plurality of applications corresponding to the given user.

7. The real time communication system of claim 2 wherein the specific end point comprises one of a plurality of different devices corresponding to the given user.

8. The real time communication system of claim 1 and further comprising one of:
an on-line meeting system conducting an on-line meeting;
a chat room system facilitating chat room communication;
an audio visual communication system facilitating real time audio visual communications; and
a gaming system facilitating real time gaming communication.

9. The real time communication system of claim 1 wherein the nudge generation component receives an automatic nudge input that meets one or more automatic nudge criteria, and automatically generates a nudge transmission for the group of users.

10. The real time communication system of claim 9 wherein the group of users comprises meeting attendees for an on-line meeting and wherein the automatic nudge input comprises a meeting leader or meeting organizer joining the on-line meeting.

11. The real time communication system of claim 9 wherein the group of users comprises attendees at an on-line presentation and wherein the automatic nudge input comprises a presenter beginning the on-line presentation.

12. A computer-implemented method comprising:
receiving, at a nudge system, a user group input identifying a group of a plurality of users;
generating, at the nudge system, a nudge transmission including context information indicative of a subject of the nudge transmission;
receiving user activation of a nudge user input mechanism; and
sending the nudge transmission from the nudge system to each user in the group of users over a communication system.

13. The computer-implemented method of claim 12 wherein generating the nudge transmission comprises including task information identifying a task common to all the plurality of users in the group.

14. The computer-implemented method of claim 13 wherein the task is to be performed using a first communication system.

15. The computer-implemented method of claim 14 wherein sending the nudge transmission comprises:
sending the nudge transmission using a second communication system, different from the first communication system.

16. The computer-implemented method of claim 15 wherein the task uses one of a cellular telephone system, a short message system, a gaming system, and an online communication system and wherein sending the nudge transmission comprises:
sending the nudge transmission using a different one of the on-line communication system, the cellular telephone system, the short messaging system and the gaming system.

17. The computer-implemented method of claim 1 wherein sending the nudge transmission comprises:
receiving a user presence input identifying a user presence state and sending the nudge transmission to one of a plurality of different end points based on the user presence state.

18. The computer-implemented method of claim 17 wherein sending the nudge transmission comprises:
accessing a set of user preferences based on the user presence state and sending the nudge transmission to the one end point based on the user preferences.

19. A computer-readable storage medium storing computer readable instructions which, when executed by a computer, cause the computer to perform a method comprising:
receiving, at a nudge system, a user group input identifying a group of a plurality of users;
generating, at the nudge system, a nudge transmission including context information indicative of a subject of the nudge transmission and including task information identifying a task common to all the plurality of users in the group, wherein the task is to be performed using a first real time communication system; and
sending the nudge transmission from the nudge system to each user in the group of users over a second real time communication system, different from the first real time communication system.

20. The computer readable storage medium of claim 19 wherein sending the nudge transmission comprises:
receiving a user presence input identifying a user presence state and sending the nudge transmission to one of a plurality of different end points based on the user presence state.
